(19) United States
(12) Patent Application Publication
(10) Pub. No.: US 2009/0008441 A1
(43) Pub. Date: Jan. 8, 2009

(54) TRACKING RF TRANSACTION ACTIVITY USING A TRANSACTION DEVICE IDENTIFIER

(75) Inventors: Joshua Montgomery, Orem, UT (US); Lee J. Peart, Epsom (GB); Peter D. Saunders, Salt Lake City, UT (US)

Correspondence Address: SNELL & WILMER L.L.P. (Main), 400 EAST VAN BUREN, ONE ARIZONA CENTER, PHOENIX, AZ, 85004-2202, US

(73) Assignee: XATRA FUND MX, LLC, Wilmington, DE (US)

(21) Appl. No.: 12/206,634

(22) Filed: Sep. 8, 2008

Related U.S. Application Data
(63) Continuation of application No. 10/711,966, filed on Oct. 15, 2004.
Application No. 10/711,966 is a continuation-in-part of application No. 10/708,569, filed on Mar. 11, 2004.
Application No. 10/708,569 is a continuation of application No. 10/192,488, filed on Jul. 9, 2002, now Pat. No. 7,239,226.
Application No. 10/708,569 is a continuation of application No. 10/340,352, filed on Jan. 10, 2003.
(60) Provisional application No. 60/512,424, filed on Oct. 17, 2003.
(60) Provisional application No. 60/304,216, filed on Jul. 10, 2001.
(60) Provisional application No. 60/396,577, filed on Jul. 16, 2002.

(51) Int. Cl. G06Q 40/00

(52) U.S. Cl. 235/379

(57) ABSTRACT

In accordance with one exemplary embodiment of the invention, a radio frequency identification (RFID) transaction device is used to complete a transaction. The RFID transaction device may communicate a tertiary number and/or a URL instead of sensitive transaction device information. The tertiary number and/or URL may point the RFID transaction device to a third-party authorizing agent. The third party may verify that the URL and/or a tertiary number corresponds to a valid transaction account on the account provider system. The third party may use the URL and/or the tertiary number to locate the appropriate verifying (e.g., “validating”) information for confirming the transaction account validity. Once the third party verifies the validity of the transaction account using the URL and/or the tertiary number, the third party (e.g., account issuer or acquirer) may provide authorization to the merchant that a transaction may be completed.

### RELATED APPLICATIONS

This application is a continuation of and claims priority to U.S. patent application Ser. No. 10/711,966, entitled “TRACKING RF TRANSACTION ACTIVITY USING A TRANSACTION DEVICE IDENTIFER,” filed on Oct. 14, 2004. The '966 is a non-provisional of and claims priority to U.S. Provisional Application No. 60/512,424, filed Oct. 17, 2003. The '966 application is also a continuation-in-part of, and claims priority to U.S. patent application Ser. No. 10/708,569, entitled “SYSTEM AND METHOD FOR SECURING SENSITIVE INFORMATION DURING COMPLETION OF A TRANSACTION,” filed Mar. 11, 2004. The '569 itself claims priority to U.S. patent application Ser. No. 10/192,488, entitled “SYSTEM AND METHOD FOR PAYMENT USING RADIO FREQUENCY IDENTIFICATION IN CONTACT AND CONTACTLESS TRANSACTIONS,” filed Jul. 9, 2002 (which itself claims priority to U.S. Provisional Patent Application No. 60/304,216, filed Jul. 10, 2001), and to U.S. patent application Ser. No. 10/340,352, entitled “SYSTEM AND METHOD FOR INCENTING PAYMENT USING RADIO FREQUENCY IDENTIFICATION IN CONTACT AND CONTACTLESS TRANSACTIONS,” filed Jan. 10, 2003 (which itself claims priority to U.S. Provisional Patent Application No. 60/396,577, filed Jul. 16, 2002), all of which are incorporated herein by reference.

### FIELD OF INVENTION

This invention generally relates to tracking activity related to a radio frequency identification (RFID) device. More particularly, the invention pertains to a system and method for tracking RF device activity using a tertiary number.

### BACKGROUND OF THE INVENTION

Like barcode and voice data entry, RFID is a contactless information acquisition technology. RFID systems are wireless, and are usually extremely effective in hostile environments where conventional acquisition methods often fail. RFID has established itself in a wide range of markets, such as, for example, the high-speed reading of railway containers, tracking moving objects such as livestock or automobiles, and retail inventory applications. As such, RFID technology has become a primary focus in automated data collection, identification and analysis systems worldwide.

Of late, companies are increasingly embodying RFID data acquisition technology in a fob or tag for use in completing financial transactions. A typical RFID fob is ordinarily a self-contained device, which may take the shape of any portable form factor. The RFID fob may include a transponder for transmitting information during a transaction. In some instances, a battery may be included in the fob to power the transponder, in which case the internal circuitry of the fob (including the transponder) may draw its operating power from the battery power source. Alternatively, the fob may gain its operating power directly from an RF interrogation signal. U.S. Pat. No. 5,053,774, issued to Schuermann, describes a typical transponder RF interrogation system which may be found in the prior art. The Schuermann patent generally describes the powering technology surrounding conventional transponder structures. U.S. Pat. No. 4,739,328 discusses a method by which a conventional transponder may respond to a RF interrogation signal. Other typical modulation techniques which may be used include, for example, ISO/IEC 14443 and the like.

In the conventional fob powering technologies used, the fob is typically activated upon presenting the fob into an interrogation signal. In this regard, the fob may be activated irrespective of whether the user desires such activation. Alternatively, the fob may have an internal power source such that interrogation by the reader for activation of the fob is not required.

One of the more visible uses of the RFID technology is the introduction of Exxon/Mobil's Speedpass® and Shell's EasyPay® products. These products use transponders, placed in a fob or tag, which enable automatic identification of the user when the fob is presented at a merchant's Point-of-Sale (POS) device, for example, when attempting to complete a transaction. During the transaction completion, information from the RFID fob is ordinarily passed to the POS, which delivers the information to a merchant system.

To complete the transaction, fob identification data typically may be passed to a third-party server database. The third-party server may reference the identification data to a customer (e.g., user) credit or debit account. In an exemplary processing method, the third-party server may seek authorization for the transaction by passing the transaction and account data to an authorizing entity, such as for example an “acquirer” or account issuer. Once the server receives authorization from the authorizing entity, the authorizing entity sends clearance to the POS device for completion of the transaction.

In addition to sending the information to an issuer system for verification, the merchant system may store the information in a merchant system database for later reference. For example, where the transaction device user is a repeat customer, the transaction device user may wish to complete the transaction using transaction account information previously submitted to the merchant system. Since the account information is stored on the merchant system, the user need not provide the information to a merchant to complete subsequent transactions. Instead, the user may indicate to the merchant to use the transaction account information stored on the merchant system for transaction completion.

In another typical example, the merchant system may store the transaction account information for later reference when the transaction device user establishes a “recurring billing” account. In this instance, the merchant may periodically charge a user for services rendered or goods purchased. The user may authorize the merchant system to seek satisfaction of the bill using the transaction account information. The merchant may thereby send a transaction request regarding the bill to an account provider, or a third-party server.

To lessen the financial impact of fraudulent transactions in the RFID environment, fob issuers have focused much effort on securing RFID transactions. Many of the efforts have focused on securing the transaction account or related data during transmission from the user to the merchant, or from the merchant to a third-party server or account provider system. For example, one conventional method for securing RFID transactions involves requiring the device user to provide a secondary form of identification during transaction completion. The RFID transaction device user may be asked to enter a personal identification number (PIN) into a keypad. The PIN may then be verified against a number associated with the user or the RFID transaction device, wherein the associated number is stored in an account issuer database. If the PIN number provided by the device user matches the associated number, then the transaction may be cleared for completion.

One problem with the issuer's efforts in securing RFID transactions is that they typically do not focus on the ways to guard the transaction account information stored on the merchant system from theft. As noted, the merchant may typically store on a merchant database the information received from the fob during a transaction. Such information may be sensitive information concerning the fob user or the fob user's account. Should the fob user's sensitive information be retrieved from the merchant system without authorization, the fob user or issuer may be subjected to fraudulent activity. The ability to secure the sensitive information stored on the merchant system is limited by the security measures taken by the merchant in securing its merchant system database. Consequently, the account provider often has little influence over the security of the account information once the information is provided to the merchant system.

As such, a need exists for a method of securing sensitive transaction account information which permits the account provider to have a significant influence on the security of the fob user information stored on a merchant system. A suitable system may secure the sensitive information irrespective of the merchant system.

### SUMMARY OF THE INVENTION

A system and method for securing transactions is described which addresses the problems found in conventional transaction securing methods. The securing method described herein includes providing a tertiary number to a merchant system during a transaction instead of providing sensitive transaction account information. A transaction device in accordance with the invention provides the tertiary number to the merchant system contemporaneously with a transaction request. The merchant system may receive the tertiary number and correlate the tertiary number to a user or transaction in the merchant system. The merchant system may store the tertiary number in a merchant database for later reference.

The tertiary number does not include any sensitive information about a fob user or user transaction account. Instead, the merchant system receives a tertiary number, which takes the place of that sensitive information ordinarily received during transaction completion. In other words, certain information such as the user's actual account number is never transmitted to the merchant. Thus, the user's account number is not available should the merchant system be compromised.

In accordance with one exemplary embodiment of the invention, a radio frequency identification (RFID) transaction device is used to complete a transaction. The RFID transaction device may be interrogated by a RFID reader operable to provide a RF interrogation signal for powering a transponder system. The RFID reader may receive a tertiary number instead of sensitive transaction device information, and the merchant may receive the RFID transaction device tertiary number from the RFID transaction device and provide the tertiary number to an authorizing agent, such as an acquirer or an account issuer, for verification.

In another embodiment, the RFID reader may receive a URL from the transaction device. The URL may point the RFID reader to a third-party authorizing agent. The third party may verify that the URL and/or a tertiary number corresponds to a valid transaction account on the account provider system. The third party may use the URL and/or the tertiary number to locate the appropriate verifying (e.g., “validating”) information for confirming the transaction account validity. Once the third party verifies the validity of the transaction account using the URL and/or the tertiary number, the third party (e.g., account issuer or acquirer) may provide authorization to the merchant that a transaction may be completed.

In one exemplary embodiment, the RFID reader may additionally be validated. In this instance, the RFID reader may be provided a RFID reader authentication tag which may be used to validate the reader. During a transaction completion, the RFID reader receives the RFID transaction device tertiary number, the reader may provide the fob tertiary number, and the reader authentication tag to an authorizing agent, such as an acquirer. In similar manner as with the transaction account, the acquirer may then validate that the RFID reader is an authorized reader for facilitating a RF transaction with the account issuer. If the RFID reader is validated, the acquirer may then provide the RFID transaction device identifier to an account provider for RFID device verification. The account issuer may then verify that the RFID transaction device is authorized to complete the requested transaction. Alternatively, the reader may be directly validated by the account issuer.

These features and other advantages of the system and method, as well as the structure and operation of various exemplary embodiments of the system and method, are described below.

### BRIEF DESCRIPTION OF THE DRAWINGS

The accompanying drawings, wherein like numerals depict like elements, illustrate exemplary embodiments of the present invention, and together with the description, serve to explain the principles of the invention. In the drawings:

FIG. 1 illustrates an exemplary RFID transaction system depicting exemplary components for use in a secure RFID transaction completed in accordance with the present invention; and

FIG. 2 depicts an exemplary flowchart of an overview of a exemplary method for securing a RFID transaction in accordance with the present invention; and

FIG. 3 illustrates an exemplary method for mapping the tertiary number and/or the URL to a merchant-specific ID in accordance with the present invention.

### DETAILED DESCRIPTION

The present invention may be described herein in terms of functional block components, screen shots, optional selections and various processing steps. Such functional blocks may be realized by any number of hardware and/or software components configured to perform the specified functions. For example, the present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), JavaCard and MULTOS with the various algorithms being implemented with any combination of data structures, objects, processes, routines or other programming elements. Further, it should be noted that the present invention may employ any number of conventional techniques for data transmission, signaling, data processing, network control, encryption and the like. For a basic introduction on cryptography, review a text written by Bruce Schneier entitled “Applied Cryptography: Protocols, Algorithms, and Source Code in C,” published by John Wiley & Sons (second edition, 1996), herein incorporated by reference.

The exemplary network disclosed herein may include any system for exchanging data or transacting business, such as the Internet, an intranet, an extranet, WAN, LAN, satellite communications, and/or the like. It is noted that the network may be implemented as other types of networks, such as an interactive television network (ITN). Further still, the terms “Internet” or “network” may refer to the Internet, any replacement, competitor or successor to the Internet, or any public or private inter-network, intranet or extranet that is based upon open or proprietary protocols. Specific information related to the protocols, standards, and application software utilized in connection with the Internet may not be discussed herein. For further information regarding such details, see, for example, Dilip Naik, Internet Standards and Protocols (1998); Java 2 Complete, various authors, (Sybex 1999); Deborah Ray and Eric Ray, Mastering HTML 4.0 (1997); Loshin, TCP/IP Clearly Explained (1997). All of these texts are hereby incorporated by reference.

By communicating, a signal may travel to/from one component to another. The components may be directly connected to each other or may be connected through one or more other devices or components. The various coupling components for the devices can include but are not limited to the Internet, a wireless network, a conventional wire cable, an optical cable or connection through air, water, or any other medium that conducts signals, and any other coupling device or medium.

The system user may interact with the system via any input device such as, a keypad, keyboard, mouse, biometric device, kiosk, personal digital assistant, handheld computer (e.g., Palm Pilot®, Blueberry®, cellular phone and/or the like. Any input device discussed herein may also be a “pervasive computing device,” which may include a traditionally non-computerized device that is embedded with a computing unit. Examples can include watches, Internet enabled kitchen appliances, restaurant tables embedded with RF readers, wallets or purses with imbedded transponders, etc.

Similarly, the invention could be used in conjunction with any type of personal computer, network computer, work station, minicomputer, mainframe, or the like, running any operating system such as any version of Windows, Windows NT, Windows 2000, Windows 98, Windows 95, MVS, MacOS, OS/2, BeOS, Linux, UNIX, Solaris, or the like. Moreover, it should be understood that the invention could be implemented using TCP/IP communications protocol, SNA, IPX, Appletalk, IPte, NetBIOS, OSI or any number of communications protocols. Moreover, the transactions discussed herein may include or result in the use, sale, or distribution of any goods, services or information over any network having similar functionality described herein.

A variety of conventional communications media and protocols may be used for data links providing physical connections between the various system components. For example, the data links may be an Internet Service Provider (ISP) configured to facilitate communications over a local loop as is typically used in connection with standard modem communication, cable modem, dish networks, ISDN, Digital Subscriber Lines (DSL), or any wireless communication media. In addition, the merchant system including a merchant point-of-sale (POS) device and host network may reside on a local area network, which interfaces to a remote network for remote authorization of an intended transaction. The POS may communicate with the remote network via a leased line, such as a T1, D3 line, or the like. Such communications lines are described in a variety of texts, such as, “Understanding Data Communications,” by Gilbert Held, which is incorporated herein by reference.

A transaction device identifier, as used herein, may include any identifier for a transaction device, such as, for example, any hardware, software, code, number, letter, symbol, digital certificate, smart chip, digital signal, analog signal, biometric and/or other identifier/indicia. The device identifier may also be correlated to a user transaction account (e.g., credit, charge debit, checking, savings, reward, loyalty, or the like) maintained by a transaction account provider (e.g., payment authorization center). A typical transaction account identifier (e.g., account number) distinct to a transaction device, may be correlated to a credit or debit account, loyalty account, or rewards account maintained and serviced by such entities as American Express®), Visa®, MasterCard® or the like.

A transaction device identifier or account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000.” In a typical example, the first five to seven digits are reserved for processing purposes and identify the issuing bank, card type and, etc. In this example, the last sixteenth digit is used as a sum check for the sixteen-digit number. The intermediary eight-to-ten digits are used to uniquely identify the customer. The account number transaction device may be stored as Track 1 and Track 2 data as defined in ISO/IEC 7813, and further may be created unique to the RFID transaction device. The account number or transaction device identifier may be communicated in Track 1 and Track 2 data, as well. Further, the account number or transaction device identifier may be communicated in any variable format.

As used herein, a transaction device may be referred to as a “fob,” although the transaction device may be embodied in any form factor such as a credit card, debit card, calling card, loyalty card, key fob, cell phone, key ring, ring, or the like.

In one exemplary embodiment, a fob may be correlated with a unique RFID transaction device account number. In accordance with the invention, the account number is not provided to a merchant during transaction completion. Instead, the merchant system may be provided a “tertiary number” and/or a URL (described below). The fob tertiary number may be stored on a transaction device database located on the fob. The fob database may be configured to store multiple tertiary numbers issued to the RFID transaction device user by the same or different account providing institutions.

To facilitate understanding, the present invention may be described with respect to a credit account. However, it should be noted that the invention is not so limited. Other accounts which facilitate an exchange of goods or services are contemplated to be within the scope of the present invention. For example, the invention contemplates the use of loyalty point accounts, incentive accounts, frequent flier account, membership accounts and the like.

The databases discussed herein may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Databases may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Block of Binary (BLOB). Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first issuer, a second data set which may be stored may be provided by an unrelated second issuer, and yet a third data set which may be stored, may be provided by an third issuer unrelated to the first and second issuer. Each of these three exemplary data sets may contain different information that is stored using different data storage formats and/or techniques. Further, each data set may contain subsets of data which also may be distinct from other subsets.

In addition to the above, the transaction device identifier (fob identifier) may be associated with any secondary form of identification configured to allow the consumer to interact or communicate with a payment system. For example, the fob identifier may be associated with, for example, an authorization/access code, personal identification number (PIN), Internet code, digital certificate, biometric data, and/or other secondary identification data used to verify a transaction device user identity.

It should be further noted that conventional components of RFID transaction devices may not be discussed herein for brevity. For example, one skilled in the art will appreciate that the RFID transaction device and the RFID reader disclosed herein include traditional transponders, antennas, protocol sequence controllers, modulators/demodulators and the like, necessary for proper RFID data transmission. A suitable RFID transaction device and RFID reader which may be used with this invention are disclosed in U.S. patent application Ser. No. 10/192,488, filed Jul. 9, 2002. As such, those components are contemplated to be included in the scope of the invention.

Various components may be described herein in terms of their “validity.” In this context, a “valid” component is one that is partially or fully authorized for use in completing a transaction request in accordance with the present invention. Contrarily, an “invalid” component is one that is not partially or fully authorized for transaction completion.

Although the present invention is described with respect to validating a transaction device or reader communicating in a RF transaction, the invention is not so limited. The present invention may be used for any device, machine, or article which provides user identifying data to a merchant. Thus, the present invention may be used in any contact or contactless environment where identifying data is transferred to a merchant.

During a typical RFID transaction, a RFID transaction device user may transmit information concerning the user's transaction account to a merchant POS. The information received by the POS may include, for example, the fob identifier or account number. The information may further include personal, demographic, biometric or statistical information related to the fob user. Upon receiving the information, the merchant POS ordinarily provides the information to a merchant system. The merchant may store the information in a merchant system database for later reference. For example, the merchant system may then reference the fob information in the event that a user wishes to complete a transaction by providing the merchant the same identifying information as the merchant has stored on the merchant system.

In most instances, fob information is stored on the merchant system database for an extended period of time. The extended storage is often because the merchant typically may wish to have the information readily available for later reference (e.g., transaction request maintenance, account or transaction request tracking, or the like). The merchant may also desire to archive fob information for later use in preparing promotional offers or solicitations or materials to be provided to the fob user.

One key disadvantage of the conventional transaction processing method described above is that the information stored by the merchant is typically “sensitive information.” Sensitive information is that information which the transaction account provider or fob user would want to guard from theft. Sensitive information may be any information or data. The sensitive information may be used to conduct a fraudulent transaction. For example, sensitive information may be the user account number, fob identifier, fob user personal data or the like. The information may be used for example to complete a transaction by reproducing the sensitive information without authorization. If sensitive information is somehow compromised or stolen, it is easily subjected to fraudulent usage. For example, should an unscrupulous person gain access to the merchant system and steal the fob identifier or account number, the person may be able to use the stolen information to place fraudulent charges on the associated transaction account. As such, the merchant may put into place special security measures designed to protect the sensitive information from theft. The merchant ordinarily makes decisions related to securing the sensitive information without consulting the account provider. The transaction account provider often must rely on the effectiveness of the merchant security measures to ensure that the information is not stolen while being stored on the merchant database. If the merchant security methods are ineffective or easily compromised, the sensitive information may be easily stolen.

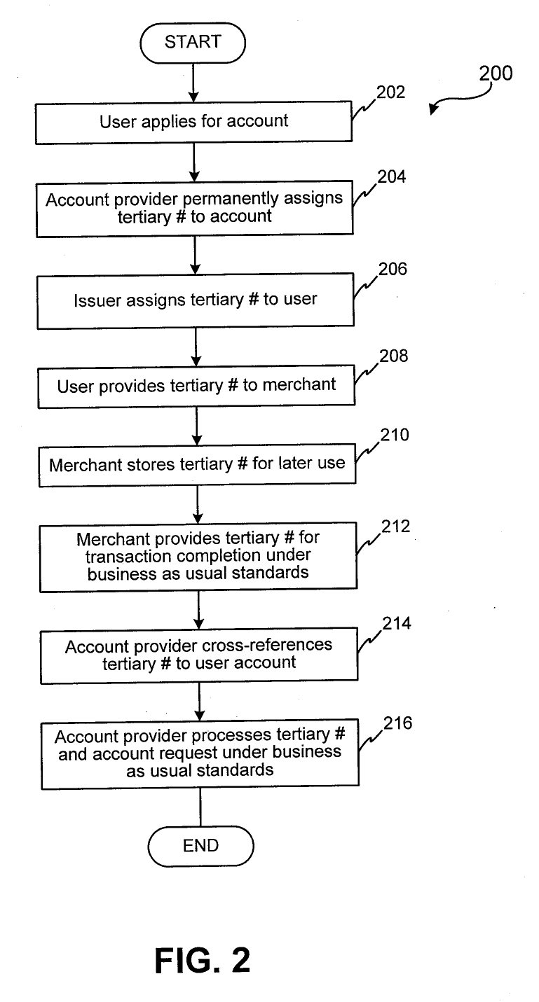

The present system and method permits the account issuer to control the level of security with which the information stored on the merchant database is protected. An exemplary method in accordance with the present invention is described in FIG. 2. In accordance with the invention, an account provider provides a transaction account to an account user for completing a transaction (step 202). The user may receive the transaction account after the user provides information concerning the user to an account provider system. For example, the user may complete an application for a credit card, and the credit card provider may provide a credit transaction account to the user for transaction completion. The account issuer may then permanently assign a tertiary number to the transaction account, so that the tertiary number need never be altered or modified during the life of the transaction account (step 204). The account issuer may store the tertiary number correlative to the related transaction account. The account issuer may store the tertiary number and the account number in a relational database, so that the account issuer could locate the transaction account by referencing the associated permanently assigned tertiary number. The account provider may then provide the tertiary number to the user, by embodying the tertiary number in any presentable form factor such as a credit card, debit card, calling card, loyalty card, key fob, cell phone, key ring, ring, or the like (step 206). The user may then provide the tertiary number to a merchant system during the completion of a transaction request (step 208). The manner in which the user provides the transaction account tertiary number to the user system may vary in accordance with the form factor in which the proxy is embodied. For example, where the tertiary number is embodied in the magnetic stripe of a conventional credit card, the user may provide the tertiary number to the merchant by “swiping” the magnetic stripe at a suitable reader as is found in the prior art. Alternatively, the tertiary number may be embodied in a transponder system associated with a key fob. In this instance the user may provide the account number to the merchant system by waiving the key fob in proximity to a suitable transponder reader. The reader may provide an interrogation signal to the transponder system to facilitate operation of the transponder system and the transponder reader may provide the tertiary number to the merchant system for processing. The merchant may receive the tertiary number and store the tertiary number in a merchant system database for later reference (step 210). For example, where the user requests that the merchant store the tertiary number in reference to a recurring billing account for payment, the merchant may store the tertiary number relative to the recurring billing account and periodically use the tertiary number to seek payment. The merchant system may then provide the tertiary number to the account issuer in a transaction request, under the merchant defined business as usual standard to facilitate completing the transaction (step 212). The account issuer may receive the tertiary number and match the tertiary number to the corresponding transaction account, which may be stored on a merchant database (step 214). The account provider may then provide to the merchant the information, or funds to complete the transaction (216). The proceeding steps additionally contemplate presenting the tertiary number to the merchant for each transaction and/or not storing the number in a merchant system database.

As used herein, the term “tertiary number” may include any device, hardware, software, code, proxy code, number, letter, symbol, digital certificate, smart chip, digital signal, URL, analog signal, biometric and/or other identifier/indicia. The tertiary number may also refer to any information provided to, for example, a merchant system during completion of a transaction request, which partially or fully masks the underlying sensitive information from the merchant system. As such, the information provided “masks” the underlying sensitive information related to the transaction account from the merchant system. Particularly, the information provided to the merchant (called “tertiary number” herein) does not include sensitive information like, for example, the transaction account number. Consequently, the merchant system is never provided the sensitive information since the sensitive information is not included in the tertiary number. Moreover, the tertiary number may take the form of any conventional transaction account identifier. As such, when the merchant receives the tertiary number, the merchant system may process the tertiary number under business as usual standards. For example, the tertiary number may take the form of any conventional transaction device identifier or account number. The merchant system thereby stores the tertiary number in the place of the information ordinarily stored under conventional processing methods. Since the tertiary number does not include sensitive information, no sensitive information may be stolen should the merchant system be compromised. In this way, the account issuer may substantially eliminate, minimize or control the risks associated with the security of the merchant system being compromised (e.g., fraudulent transactions, identity theft, etc.).

Another advantage of the present invention is that since the tertiary number is permanently associated with a transaction account, the tertiary number need never be modified in the merchant system. As such, the present invention eliminates the need to update information on the merchant system every time the related transaction device is lost, stolen, or replaced. More particularly, the replacement device is provided the identical tertiary number as was provided to the original transaction device. Consequently, the merchant is provided the identical tertiary number in any instance where the user wishes to complete a transaction using the transaction account which the account provider has permanently associated with the tertiary number.

For example, the merchant may receive the tertiary number and store the tertiary number related to a recurring billing account such as a telephone account. Periodically the merchant may bill a transaction device user in accordance with the telephone services provided. The device user may wish to provide the merchant with transaction device information the merchant may use to satisfy the bill. The user may authorize the merchant to store the device information for repeated use in satisfying the bill. In a conventional recurring billing environment, the device information must ordinarily be updated when the user loses the device or the device information expires. That is, the replacement device often is given device information which is often different from the information contained on the original transaction device. However, in accordance with the present invention, the merchant need not update transaction device information because the tertiary number is permanently associated with the transaction account.

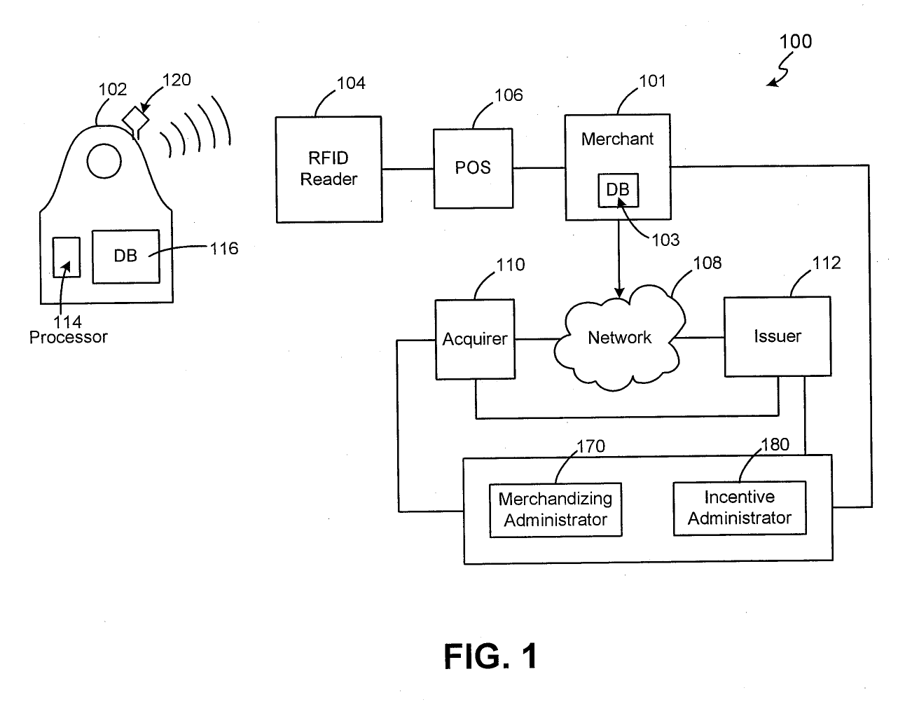

FIG. 1 illustrates an exemplary RFID transaction system 100 in accordance with the present invention, wherein exemplary components for use in completing a RF transaction are depicted. In general, system 100 may include a RFID transaction device (fob) 102 in RF communication with a RFID reader 104 for transmitting data therebetween. RFID reader 104 may be in further communication with a merchant point-of-sale (POS 106) device 106 for providing to POS 106 information received from fob 102. POS 106 may be in further communication with a merchant system 101, which may include a merchant database 103. Merchant system 101 may be in communication with an acquirer 110 or an account issuer 112 via a network 108 for transmitting transaction request data and receiving authorization concerning transaction completion.

Although POS 106 is described herein with respect to a merchant point-of-sale (POS) device, the invention is not to be so limited. Indeed, a merchant POS device is used herein by way of example, and the point-of-sale device may be any device capable of receiving transaction device account information from fob 102. In this regard, POS 106 may be any point-of-interaction device, such as, for example, a merchant terminal, kiosk, user terminal, computer terminal, input/output receiver or reader, etc., enabling the user to complete a transaction using fob 102. POS device 106 may receive fob 102 information and provide the information to merchant system 101 for processing.

As used herein, an “acquirer” may be any databases and processors (e.g., operated by a third party) for facilitating the routing of a payment request to an appropriate account issuer 112. Acquirer 110 may route the payment request to account issuer 112 in accordance with a routing number, wherein the routing number corresponds to account issuer 112. The routing number may be provided by fob 102. The “routing number” in this context may be a unique network address or any similar device for locating account issuer 112 on a network 108. In one exemplary embodiment, the routing number may typically be stored on one of the “tracks” comprising a magnetic stripe network. For example, the tertiary number may be provided in traditional ISO magnetic stripe format. The routing number may be typically stored in Track 1/Track 2 format so that the information may be interpreted by POS device 106 and merchant system 101. Traditional means of routing the payment request in accordance with the routing number are well understood. As such, the process for using a routing number to provide a payment request will not be discussed herein.

In addition, account issuer 112 (or account provider) may be any entity which provides a transaction account useful for facilitating completion of a transaction request. The transaction account may be any account which maintains credit, debit, loyalty, direct debit, checking, savings, or the like. The term “issuer” or “account provider” may refer to any entity facilitating payment of a transaction using a fob, and which may include systems permitting payment using at least one of a preloaded and non-preloaded fob 102. Typical issuers may be American Express, MasterCard, Visa, Discover, and the like.

In general, during operation of system 100, RFID reader 104 may provide an interrogation signal to fob 102 for powering fob 102 and receiving fob 102 related information. The interrogation signal may be received at the fob 102 antenna 120 and may be further provided to a transponder (not shown). In response, the fob processor 114 may retrieve fob 102 information from fob database 116 for providing to RFID reader 104 to complete a transaction request. Typically, where fob 102 information includes a fob identifier or authentication tag, the identifier and tag may be encrypted prior to providing the information to reader 104.

It should be noted that RFID reader 104 and fob 102 may engage in mutual authentication prior to transferring any fob 102 data to reader 104. For a detailed explanation of a suitable mutual authentication process for use with the invention, see commonly owned U.S. patent application Ser. No. 10/340,352, entitled “SYSTEM AND METHOD FOR INCENTING PAYMENT USING RADIO FREQUENCY IDENTIFICATION IN CONTACT AND CONTACTLESS TRANSACTIONS,” filed Jan. 10, 2003, incorporated herein by reference in its entirety.

Once RFID reader 104 receives the fob information, the reader 104 provides the information to merchant POS 106 which provides the information to merchant system 101. Merchant system 101 may then append the fob 102 information with transaction request data and provide the entire transaction request (i.e., transaction request data and fob 102 information) to acquirer 110 or issuer 112 for transaction completion. The transmitting of the information from fob 102 to acquirer 110 (or issuer 112) may be accomplished in accordance with any conventional method for completing a transaction using contact and wireless data transmission. Acquirer 110 or issuer 112 may then determine whether to authorize completion of the transaction request in accordance with any business as usual protocol.

In addition to appending the fob information to the transaction request data for transaction authorization, conventional merchant systems may also store the fob information in a merchant system database (not shown) for later reference. For example, a particular merchant may want to provide special advertisements to the user of fob 102 based on the user's prior purchases at the merchant location. Merchant system 101 may then recall the fob information and use the information to prepare, for example, a repeat customer mailing list. In some cases, however, merchant system 101 often also stores sensitive information related to the user such as, for example, the user's account number (e.g., credit card number) associated with fob 102. This sort of information is typically very easy to use in fraudulent transactions and therefore must be secured from theft. As such, conventional merchant systems use special security methods to safeguard the sensitive information from theft.

Account issuer 112 may provide additional security by assigning a permanent fixed tertiary number to fob 102 transaction account. (step 204 of FIG. 2). The tertiary number may not itself include sensitive information. The tertiary number may be associated with a user's transaction account number on a merchant database 103. Account issuer 112 may then provide the tertiary number, and not the transaction account number, to the user in a suitable form factor such as, fob 102 discussed above (step 206). Fob 102 user may then provide the tertiary number to merchant system 101 during the completion of transaction (step 208). Merchant system 101 may then process the tertiary number as a part of a transaction request and may provide the tertiary number to account issuer 112 for processing under merchant and account issuer business as usual standards (step 212). Merchant system 101 may also store the account tertiary number for later reference (step 210). Since the tertiary number is permanently assigned to the transaction account, the merchant system never needs to modify the tertiary number on merchant system 101. Merchant system 101 may store the tertiary number on merchant database 103 using any method the merchant ordinarily uses to store customer data.

In assigning the tertiary number, issuer system 112 may first permit fob 102 user to open a transaction account for use in completing a transaction request (step 202). The user may open a transaction account by providing personal or demographic information and the like to issuer system 112 which may use the information to assign a transaction account and account number to the user. The transaction account may be identified by the account number in issuer system 112 database (not shown), and issuer system 112 may be able to reference the transaction account using the account number when authorizing a transaction (step 214).

In this context, the account number is considered sensitive information. Issuer system 112 may then assign a tertiary number to the transaction account (step 204). In assigning the tertiary number, issuer system 112 may correlate or match the tertiary number to the account number in, for example, a relational database. The algorithm may be such that it will receive the tertiary number and operate on the tertiary number to convert the tertiary number to a number correlated with the transaction account number. Alternatively, account issuer 112 may store the tertiary number in a one to one relationship with the account number. Further still, account issuer 112 may use any suitable correlation technique that is known which permits the account issuer system to receive one data and associate it with a second data. In other embodiments, the tertiary number may be derived from the account number or any other data field, where the tertiary number is stored, for example, in data fields on fob 102. Where the tertiary number is accompanied by a secondary identifier, such as, for example, a personal identification number (PIN), issuer system 112 database may correlate or match the tertiary number, account number and secondary identifier, so that issuer system 112 may reference any one of the numbers using any one of the other numbers. Issuer system 112 may use any conventional matching or storage protocol as is found in the art.

In one exemplary embodiment, issuer system 112 may assign distinct tertiary numbers for each transaction account of issuer system 112. In which case, no two transaction accounts would be assigned identical tertiary numbers. In another exemplary embodiment, issuer system 112 may assign the same tertiary number to a plurality of transaction accounts, to multiple accounts related to the same cardholder, to multiple accounts controlled by the same entity (e.g., corporate card accounts), to all the transaction accounts issuer system 112 maintains or any other subset of accounts. In yet another exemplary embodiment, issuer 112 may assign a tertiary number to a specific device. That is, if a user has multiple devices for payment, each device may have a different tertiary number. In another embodiment, the user may decide whether the user would prefer to have a unique tertiary number per device or a unique tertiary number for multiple accounts associated with that user.

Moreover, a tertiary number may not be a separate code, rather, the tertiary number may be derived from the fob identifier or any other data. In another embodiment, the tertiary number may be contained within another code or account number. In another embodiment, the tertiary number is an encrypted or manipulated account number (or any other sensitive information). The same tertiary number, an amended tertiary number or an additional tertiary number may also represent other sensitive data (aside from the account number), such as, for example, account holder name, address, biometric information, demographic information and/or the like. In this regard, the merchant system will not have access to this information, but the tertiary number related to this information will be sent to the acquirer when the acquirer requires any portion of this information as part of its approval process.

The tertiary number is then loaded onto fob 102. In other embodiments, the device may generate its own tertiary number. In this embodiment, the user may download the generated tertiary number to the issuer (e.g., via the Internet) prior to using the code in a transaction. In another embodiment, the reader, POS or merchant system may generate a tertiary number prior to, during or after receiving sensitive information. In this embodiment, the reader may delete the sensitive information, and only transmit the tertiary number to complete the transaction.

While fob 102 may only contain the tertiary number, in certain embodiments, fob 102 may also contain the account number and other sensitive data; however, fob 102 will only communicate the tertiary number to the reader. In one exemplary embodiment, the tertiary number is configured in magnetic stripe format. That is, the tertiary number may be stored in the Track 1/Track 2 portions of the magnetic stripe track network. The tertiary number may be uploaded onto fob 102 which account issuer 112 has assigned to a user (step 230). The tertiary number may be uploaded into fob database 116 in magnetic stripe format, and may also be transmitted to merchant system 101 in similar magnetic stripe format. A suitable method for providing the tertiary number to fob 102 may be determined by fob 102 configuration. For example, conventional methods and magnetic stripe read/write devices may be used to encode the tertiary number in one location on one of the magnetic stripe tracks. Alternatively, the tertiary number may be uploaded into a database or other storage area contained on fob 102, by populating the tertiary number on the database using any conventional method. A suitable method is described in commonly owned U.S. patent application Ser. No. 10/192,488, entitled “SYSTEM AND METHOD FOR RFID PAYMENT USING RADIO FREQUENCY IDENTIFICATION IN CONTACT AND CONTACTLESS TRANSACTIONS,” incorporated herein by reference. Once the tertiary number is uploaded into the transaction account database, fob 102 may be used for transaction completion (step 208).

In this embodiment, the transaction account may also be assigned a secondary form of identification which may be encrypted, and which may not be available to merchant system 101. The secondary form of identification may be correlated to the transaction account on issuer system 112 so that issuer system 112 may later reference the transaction account for transaction completion.

Once the tertiary number is assigned and loaded on fob 102, the tertiary number may be provided during the execution of a transaction in lieu of the actual transaction account number. In this way, the tertiary number masks the actual account number from merchant system 101 and from potential theft. Thus, instead of merchant system 101 storing the account number for later reference, merchant system 101 stores the tertiary number.

As noted, in one exemplary embodiment, the tertiary number is formatted to mimic conventional transaction device sensitive information, such as an account number. Because the tertiary number mimics an account number or any other sensitive data and is configured in a format recognizable to merchant system 101, merchant system 101 is unable to distinguish between the tertiary number and the actual account number. For example, where the actual account number is a credit card number, the tertiary number would be configured to take the form of a valid credit card number. Similarly, where the actual account number is a loyalty number, the tertiary number is configured in a format similar to a valid loyalty number. In either case, however, the tertiary number may contain no or minimal sensitive information related to the user account.

As shown, a secure RFID transaction in accordance with this embodiment may begin when fob 102 enters the interrogation zone of RFID reader 104 and is interrogated, such as when fob 102 is used to complete a transaction request (step 208). Fob 102 information, including the tertiary number, fob 102 encrypted identifier (where included), and account issuer 112 routing number, may then be provided to fob processor 114 for transmitting to RFID reader 104 via RF transmission.

RFID reader 104 may receive fob 102 information, including the tertiary number, and if necessary, convert the information into a POS recognizable format. The converted information may then be provided to merchant system 101 via POS 106. Merchant system 101 may receive fob 102 information and combine the information with information concerning the requested transaction to produce a transaction request. The transaction information may include a product or merchant location identifier, as well as the terms for satisfying the transaction (e.g., price to be paid, barter points to be traded, loyalty points to be redeemed). Because the tertiary number is in the same format as the account number or other sensitive data, the merchant system 101 recognizes the information as valid data for the respective field. The merchant system 101 may then provide the transaction request to acquirer 110 via network 108 for transaction request completion.

Acquirer 110 may, in turn, provide the transaction request to the appropriate account issuer 112 for processing (step 212). Acquirer 110 may identify the appropriate account issuer 112 using the routing number provided by fob 102 to locate the network address corresponding to account issuer 112, thereby permitting acquirer 110 to provide the transaction request to account issuer 112 maintaining the corresponding transaction device account.

Account issuer 112 may receive the transaction request and process the transaction request in accordance with the issuer system defined protocol.

In accordance with another exemplary embodiment in accordance with the present invention, a tertiary number may be stored on fob 102 and used for non-payment purposes. For example, in one embodiment, the tertiary number may be used by merchant 101 to track usage at the merchant's business by the user and/or to provide incentives to the user.

In another exemplary embodiment, merchant 101 may supply a mapping of the tertiary number assigned to a user's fob 102 to the merchant's database 113. This mapping may facilitate identification of the user. For example, currently the grocery store Smith's has a FRESH-VALUE program that offers discounts to members. The members are identified based on the number on the member's FRESH-VALUE card.

System 100 may also include an incentive administrator 180 configured to emit an offer signal 182 indicative of an incentive offer. Optionally, incentive administrator 180 may be configured to receive user identity signal 192 and to select, adapt, configure, or otherwise modify offer signal 182 based at least in part on the tertiary number. For example, in an exemplary embodiment, once the tertiary number is known by incentive administrator 180, the tertiary number may be mapped on merchant's database 113 such that attributes or characteristics of the user's account may be used as factors in configuring offer signal 182. Exemplary factors to be considered in configuring offer signal 182 may include user's age, gender, purchasing history, time/duration and/or location/path occupied/traversed by user inside and/or outside merchant's 101 establishment, economic information regarding the user and/or population in general, or the like. Incentive administrator 180 may be preconfigured with incentive information or may be configured to receive incentive information from acquirer 110 or issuer 112.

For more information on incentive/loyalty systems, transaction systems, electronic commerce systems and digital wallet systems, see, for example, U.S. patent application Ser. No. 09/836,213, filed Apr. 17, 2001, by inventors Voltmer, et al., entitled “SYSTEM AND METHOD FOR NETWORKED LOYALTY PROGRAM”; U.S. Continuation-In-Part patent application Ser. No. 10/027,984, filed Dec. 20, 2001, by inventors Ariff, et al., entitled “SYSTEM AND METHOD FOR NETWORKED LOYALTY PROGRAM”; U.S. Continuation-In-Part patent application Ser. No. 10/010,947, filed Nov. 6, 2001, by inventors Haines, et al., entitled “SYSTEM AND METHOD FOR NETWORKED LOYALTY PROGRAM”; the Shop AMEX™ system as disclosed in Ser. No. 60/230,190, filed Sep. 5, 2000; the MR as Currency™ and Loyalty Rewards Systems disclosed in Ser. No. 60/197,296, filed Apr. 14, 2000, Ser. No. 60/200,492, filed Apr. 28, 2000, Ser. No. 60/201,114, filed May 2, 2000; a digital wallet system disclosed in U.S. Ser. No. 09/652,899, filed Aug. 31, 2000; a stored value card as disclosed in U.S. Ser. No. 09/241,188, filed Feb. 1, 1999; a system for facilitating transactions using secondary transaction numbers disclosed in Ser. No. 09/800,461, filed Mar. 7, 2001, and also in related provisional applications Ser. No. 60/187,620, filed Mar. 7, 2000, Ser. No. 60/200,625, filed Apr. 28, 2000, and Ser. No. 60/213,323, filed May 22, 2000, all of which are hereby incorporated by reference.

A merchandizing administrator 170 may also be configured to communicate incentive information to incentive administrator 180. In accordance with an exemplary embodiment, merchandizing administrator 170 may also be configured to receive a tertiary number from incentive administrator 180 for use in configuring incentive information to be communicated to merchant 101 and/or issuer 112. In accordance with another exemplary embodiment, merchandizing administrator 170 may be configured to receive collected merchandizing information from issuer 112 and/or acquirer 110 and to analyze such information in order to improve the effectiveness of the merchandizing process. For example, merchandizing administrator 170 may be configured to formulate test incentive offerings to be communicated as incentive information to incentive administrator 180 for presentation to certain fobs associated with certain tertiary numbers as incentive information. It should also be noted that incentive information may be specifically tailored for presentation to a specific tertiary number.

In another embodiment, issuer 112 and/or a third-party service may facilitate mapping and other user/merchant specific non-payment services. For example, issuer 112 and/or a third party may place a uniform resource locator (URL) on the fob that it issues. The URL can be loaded in a variety of ways. For example, the URL may be loaded during manufacture of the chip (e.g. “masking”), following the manufacture of the chip (during chip personalization) using either a contact or contactless (RF reader) interface to the chip, and/or using an RF reader after the fob is in the customer's possession. If the “URL” is specific to IETF RFC2396 (see ietf.org) then it may contain anything allowed by that specification. The tertiary number may be used as a unique number that is used to identify a specific user. A user may be further defined as being one person or a group of people having some close relationship such as being part of the same family or company, or similar association. The URL may be a standardized “locator” or internet address used to identify a destination system.

The URL may point to an issuer 112 and/or a third-party supplied mapping service. The issuer-supplied and/or third-party supplied service may include mapping, loyalty and/or advertising services as described below. As used herein, third-party services may include loyalty services, membership services, financial services and the like. In the broadest sense, the URL and tertiary number are not different in that they both consist of a string of characters. However, URLs are more narrowly defined by IETF RFC2396, while the tertiary number may be similar to a financial account number.

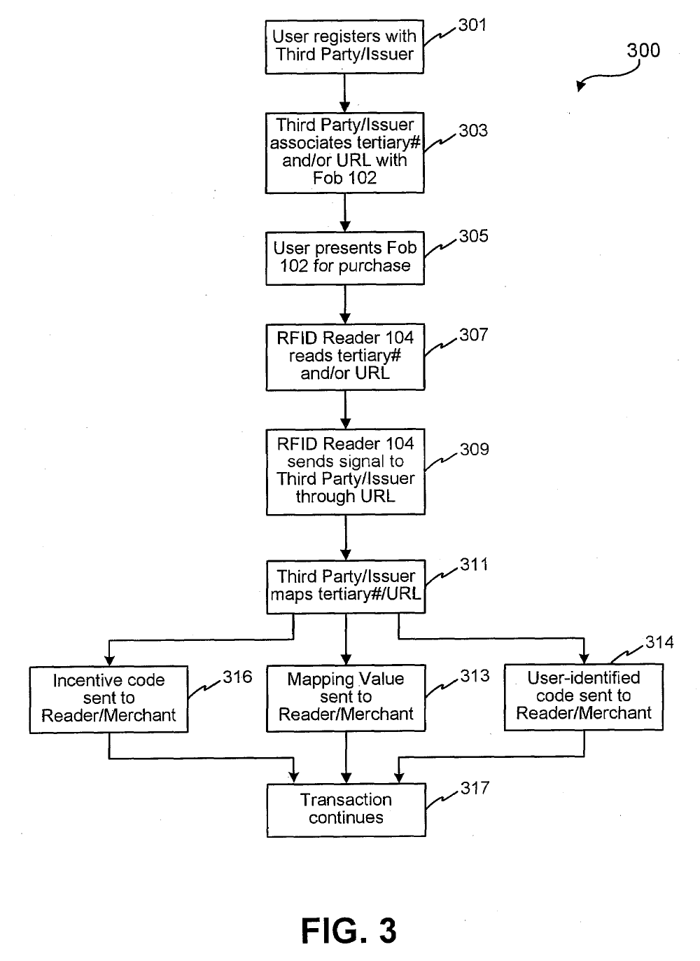

Mapping services may include mapping the tertiary number and/or the URL to a merchant-specific ID for the user. A method 300 for mapping the tertiary number and/or the URL to a merchant-specific ID in accordance with the present invention is illustrated in FIG. 3. The user may first register with the issuer and/or third party (step 301). The user may register as a customer of a specific merchant 101, as a member of a specific loyalty program, as a holder of a specific financial account and/or the like. The user may use the URL to locate the issuer and/or third-party service and/or the user may register with the issuer and/or third-party service supplier directly. Since the URL is in a fob it is not directly “clickable” it may be used in a variety of ways. For example, the system reading the URL through the RF reader may direct the user, issuer and/or third party to a location where further information is available. This location could be a server for that facilitates processing the transaction, providing account status information, and/or or providing information. As another example, the URL may be used to direct the customer to a location that may be used for providing specific account holder information (e.g. cardholder benefits, account status, configuration, information about a membership program, etc.

The issuer and/or third-party service may associate a tertiary number and/or a URL with the user and/or the user's fob (step 303). The user may then use fob 102 to make a purchase (step 305). During the purchase, RFID reader 104 may read the tertiary number and/or the URL from fob 102 and/or obtain the tertiary number and/or the URL from the user directly (step 307). RFID reader 104 may use one or more software and/or hardware components to read the tertiary number or URL. RFID reader 104 may then send a signal to the issuer and/or third-party service through the URL (step 309). The signal may trigger the issuer and/or third party to map the tertiary number to a specific user and/or merchant ID (step 311). The issuer and/or third party may map the tertiary number in any manner consistent with the methods discussed herein. Once the mapping is complete, the mapping value is transmitted back to RFID reader 104 and/or merchant 101 (step 313) for processing.

Use of the tertiary number and/or the URL may be facilitated by selecting an application on the fob that stores this information (for example, in a similar manner to selecting the payment application on the fob). This selection method is described herein with respect to the protocol for the fob payment application. Alternatively, the reader and/or POS terminal may be configured to read a specific file directory used to contain data records which store the URL and tertiary number. For example, a protocol may be used that that selects an application on a fob. If the application is not present on the fob, a negative response may be sent by the fob to the reader and/or POS terminal. If the application has been stored, on the fob, then a positive response may be provided and the data may be returned to the Reader/POS terminal. The terminal may then use the URL to set up a connection over the Internet to the destination system, and pass the user data (tertiary number and maybe other user identification data) to the system.

Alternatively and/or additionally, the issuer and/or third-party service provider may be used to provide a user-identified code to RFID reader 104 and/or the merchant (step 314), wherein the code indicates to the merchant that the user has been identified. In addition and/or in the alternative, the issuer and/or third-party service provider may also provide an incentive code to RFID reader 104 and/or the merchant to prompt the merchant to credit the user with one or more incentives (i.e., discounts) and/or loyalty points (step 316). The merchant may then progress through the transaction as normal using the tertiary number and/or the merchant-specific user ID and/or the incentive points (step 317).

In another exemplary embodiment, fob 102 may be configured with one or more tertiary numbers and/or URLs for use in different markets and/or countries. That is, different URLs can be placed on devices issued in markets or countries where legal restraints prevent a third-party service being offered outside the country. For example, for payment devices issued in the USA, one URL may be provided; for payment devices issued in the UK, a different URL may be provided.

In yet another exemplary embodiment, the URL and/or tertiary number may be used such that if the issuer and/or third-party service provider needs to change the URL and/or tertiary number, this can be done in a manner that does not impact the thousands of merchants that may be using the service. For example, if a user's account number expires and the issuer and/or third party assigns a new number to the user, this change can take place at the issuer and/or third party. That is, the new account number may be associated and/or mapped to the old tertiary number and/or URL such that the merchant will see the same URL and/or tertiary number irrespective of the account change.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. In addition, the steps recited in any of the method or process claims may be executed in any order and are not limited to the order presented or method steps may be added or eliminated as desired. Further, the present invention may be practiced using one or more servers, as necessary. Thus, the preceding detailed description is presented for purposes of illustration only and not of limitation, and the scope of the invention is defined by the preceding description, and with respect to the attached claims.

What is claimed is:

1. A method for facilitating a Radio Frequency (RF) payment transaction at a transaction processing entity, comprising:
correlating a transaction device identifier to a payment account code;
providing the transaction device identifier to an RF payment device using an internet connection;
receiving, from a merchant system, a transaction request comprising the transaction device identifier, a transaction value, and a merchant system authentication tag;
authenticating the merchant system tag;
associating the transaction device identifier with the payment account code; and
providing authorization for the RF payment transaction to the merchant system when the merchant system authentication tag is authenticated.

2. The method of claim 1, wherein the merchant system is not provided the payment account code during the RF payment transaction.

3. The method of claim 1, wherein the transaction device identifier is provided in Track 1/Track 2 format.

4. The method of claim 1, wherein the transaction device identifier is provided in a data record of variable format.

5. The method of claim 1, further comprising:
updating the payment account code; and
associating the updated payment account code with the transaction device identifier without modifying the transaction device identifier.

6. The method of claim 1, further comprising:
storing at least one of a plurality of loyalty account numbers and a plurality of rewards account numbers associated with the transaction device identifier;
selecting a loyalty account number from a plurality of loyalty account numbers, the loyalty account number corresponding to the merchant system and the transaction device identifier; and
transmitting the loyalty account number to the merchant system.

7. The method of claim 1, further comprising providing a URL to the RF payment device wherein the URL is unique to at least one of the RF payment device, the payment account code, and the transaction processing entity.

8. The method of claim 7, further comprising:
receiving, from the merchant system, the URL associated with the RF payment device;
associating the URL with at least one of the transaction device identifier and the payment account code; and
facilitating the RF payment transaction using at least one of the correlative transaction device identifier and the correlative payment account code.

9. The method of claim 7, wherein the URL is the transaction device identifier.

10. A method for tracking Radio Frequency (RF) transaction device activity using an RF Identification (RFID) reader, comprising:
receiving a transaction device identifier from an RF transaction device;
mapping the transaction device identifier;
configuring an incentive offer based on at least one factor associated with the transaction device identifier; and
transmitting the incentive offer to the RF transaction device.

11. The method of claim 10, wherein the at least one factor associated with the transaction device identifier includes: the duration the RFID reader has received the transaction device identifier, the location of the RF transaction device, a path traversed by the RF transaction device, a purchasing history associated with the RF transaction device, a user's gender associated with the RF transaction device, a user's age associated with the RF transaction device, and general economic information of a consumer group.

12. The method of claim 10, wherein the incentive offer is associated with at least one of a loyalty account number and a rewards point account.

13. The method of claim 10, further comprising analyzing the at least one factor to improve the effectiveness of a merchandizing process.

14. A Radio Frequency (RF) payment device comprising:
a first RF transponder to receive a device authentication code from an RF Identification (RFID) reader;
a protocol/sequence controller to communicate with the first RF transponder;
a transaction device identifier associated with a corresponding account code maintained at a transaction processing entity;
a unique device identification code;
a unique device encryption key corresponding to the transaction device identifier; and
a device authentication circuit to communicate with the database and the protocol/sequence controller, wherein the device authentication circuit is configured to use the unique device encryption key to encrypt the device authentication code and is configured to use the unique device encryption key to encrypt the transaction device identifier;
wherein the first RF transponder is configured to transmit at least one of the encrypted device authentication code and the encrypted transaction device identifier to the RFID reader.

15. The RF payment device of claim 14, further comprising a second RF transponder.

16. The RF payment device of claim 15, wherein at least one of the first RF transponder and the second RF transponder is configured to transmit an RFID reader authentication code to the RFID reader, and wherein at least one of the first RF transponder and the second RF transponder is configured to receive an encrypted RFID reader authentication code from the RFID reader.

17. The RF payment device of claim 16, further comprising an RFID reader decryption key, wherein the device authentication circuit is configured to use the RFID reader decryption key to decrypt the encrypted RFID reader authentication code received from the RFID reader in order-to authenticate the RFID reader.

18. The RF payment device of claim 17, wherein the unique device identification code comprises a personalized unique device identification code, wherein the unique device encryption key comprises a personalized unique device encryption key, wherein the transaction device identifier comprises a personalized transaction device identifier, and wherein the RFID reader decryption key comprises a personalized RFID reader decryption key.

19. The RF payment device of claim 15, wherein the protocol/sequence controller is configured to be in communication with at least one of the first RF transponder and the second RF transponder via a modulator/demodulator.

20. The RF payment device of claim 15, further comprising an enable/disable switch configured to enable/disable at least one of the first RF transponder and the second RF transponder.

21. The RF payment device of claim 15, wherein the RF payment device is an RF payment fob.

22. A method for facilitating a Radio Frequency (RF) payment transaction using a transponder at an RF payment device, comprising:
receiving, from a transaction processing entity, a transaction device identifier corresponding to a payment account code;
receiving an RF interrogation signal from an RFID reader, wherein the RF interrogation signal comprises a payment device authentication code;
activating a transponder system authentication circuit in response to the RF interrogation signal;
encrypting the payment device authentication code with a unique encryption key; providing an encrypted payment device authentication code and a unique payment device identification code to the RFID reader;
decrypting an encrypted RFID reader authentication code;
comparing the decrypted RFID reader authentication code to an RFID reader authentication code;
authenticating the RFID reader when the decrypted RFID reader authentication code matches the RFID reader authentication code; and
transmitting the transaction device identifier to the RFID reader.

23. The method of claim 22, wherein the RFID reader receives the encrypted RFID reader authentication code and the unique payment device identification code, associates a unique payment device decryption key stored in an RFID reader database with the unique payment device identification code, decrypts and compares the encrypted. RFID reader authentication code to the payment device authentication code, and authenticates the RF payment device when the decrypted payment device authentication code matches the payment device authentication code.

24. The method of claim 22, further comprising:
receiving a second RF interrogation signal from the RFID reader; and
wherein a second transponder is configured to be responsive to the second RF interrogation signal.
